(19) United States
(12) Patent Application Publication
(10) Pub. No.: US 2005/0189750 A1
(43) Pub. Date: Sep. 1, 2005

(54) Hybrid inflator

(76) Inventors: Yuzo Gotoh, Himeji-shi (JP); Masayuki Nakayasu, Himeji-shi (JP); Naoki Matsuda, Himeji-shi (JP)

Correspondence Address: BIRCH STEWART KOLASCH & BIRCH, PO BOX 747, FALLS CHURCH, VA, 22040-0747, US

(21) Appl. No.: 11/046,728

(22) Filed: Feb. 1, 2005

Related U.S. Application Data
(60) Provisional application No. 60/541,502, filed on Feb. 4, 2004.

(30) Foreign Application Priority Data
Feb. 2, 2004 (JP) 2004-24988

(51) Int. Cl. B60R 21/26

(52) U.S. Cl. 280/737

(57) ABSTRACT

The present invention provides a hybrid inflator in which ignitability of a gas generating agent is improved.

A combustion chamber housing 40 storing a gas generating agent 41 is provided inside a cylindrical housing 11 charged with helium. The combustion chamber housing 40 is connected to an igniter housing 20 via a first rupturable plate 50. Since the diameter of the first rupturable plate 50 and the inner diameter of the combustion chamber housing 40 are substantially equal, ignition energy from an igniter 22 passes into the combustion chamber housing 40 efficiently, thus improving the ignitability of the gas generating agent.

### FIELD OF THE INVENTION

The present invention relates to a hybrid inflator suitable for use in an air bag system for a lateral collision.

### RELATED ART

In an air bag system installed in a vehicle, the gap between a passenger and the structural components of the vehicle (the door panel and so on) is narrow, and hence the inflation speed of the air bag has to be set higher than that of the driver side and front passenger side in order to protect the passenger at a lateral collision.

Therefore, in this type of air bag system for use in a lateral collision, an inflator which uses a pressurized gas such as helium or argon is employed as the air bag inflation means. Further, in order to secure a predetermined inflation pressure easily, a hybrid inflator using both a pressurized gas and a combustion gas is employed as the air bag inflation means.

When the vehicle crashes, the hybrid inflator has to ignite and burn a gas generating agent using an igniter, and discharge the pressurized gas that is charged into an enclosed space, and hence the constitution of the hybrid inflator is more complicated than that of an inflator which uses only pressurized gas as the air bag inflation means.

US-A1 2003/57689 and U.S. Pat. No. 5,788,275 are cited as the prior art relating to the present invention.

### DISCLOSURE OF THE INVENTION

An object of the present invention is to provide a hybrid inflator that can be provided with a simpler constitution, and that is capable of inflating an air bag by discharging gas more quickly.

As the means for achieving this object, the present invention provides a hybrid inflator comprising a cylindrical housing, both ends of which are open and the interior of which is charged with a pressurized gas, an igniter housing attached to an opening portion on one end of the cylindrical housing, in which ignition means are accommodated, and a diffuser portion attached to an opening portion on the other end of the cylindrical housing and provided with a gas discharge port,
wherein the hybrid inflator further comprises a combustion chamber housing storing a gas generating agent, the combustion chamber housing is disposed within the cylindrical housing, connected to the igniter housing, and provided with a through hole in a wall surface thereof,
a first communication path between the igniter housing and the combustion chamber housing is closed by a first rupturable plate, and a second communication path between the diffuser portion and the cylindrical housing is closed by a second rupturable plate,
the first rupturable plate comprises a circular closing portion which closes the first communication path, and a fixing portion on the peripheral edge of the closing portion and the outer diameter of the first rupturable plate and the inner diameter of the combustion chamber housing are identical or similar.

By making the outer diameter of the first rupturable plate (i.e. the combined diameter of the closing portion and fixing portion) and the inner diameter of the combustion chamber housing identical or similar, ignition energy (flame and high temperature gas) generated in the igniter housing passes over the gas generating agent in the combustion chamber housing efficiently such that contact between the ignition energy and the gas generating agent is increased. As a result, the ignitability and combustibility of the gas generating agent is improved.

By improving the ignitability and combustibility of the gas generating agent in this manner, the internal pressure of the cylindrical housing rises more quickly, thereby shortening the rupture time of the second rupturable plate which is ruptured by the increase in internal pressure.

By means of this operational process, the time from the vehicle collision to the beginning of air bag inflation is shortened, which is particularly suitable for an air bag system for use in lateral collisions. Note that when helium, which has a high sound velocity (970 m/sec) is used as the pressurized gas, the time required for the second rupturable plate to rupture can be shortened even further, and hence the inflation time of the air bag can also be shortened.

In the hybrid inflator of the present invention, the combustion chamber housing and the first rupturable plate may be formed integrally.

By forming the combustion chamber housing and the first rupturable plate as an integral body, manufacture of the component and attachment thereof to the inflator are made simpler than when the combustion chamber housing and first rupturable plate are provided as separate members.

Note that when the combustion chamber housing and first rupturable plate are formed as an integral body in this manner, the first rupturable plate is preferably provided with a weak portion to ensure that only the first rupturable plate is ruptured quickly by the ignition energy generated when the igniter is activated. The weak portion needs to be provided in consideration of both rupturability and pressure resistance to the pressurized gas, and therefore methods such as inserting a cross-shaped shallow notch partway into the central portion of the first rupturable plate, making the central portion thinner than the periphery, and so on, for example, may be applied to form the weak portion.

The hybrid inflator of the present invention may also be designed such that the combustion chamber housing comprises a peripheral surface portion and a base surface portion, the combustion chamber housing is connected to the first communication path at the opening portion, a through hole(s) is provided only in the peripheral surface portion, and the through holes are positioned directly opposite an inner wall surface of the cylindrical housing with a gap therebetween.

When the gas generating agent inside the combustion chamber housing burns, the resulting combustion gas sometimes contains a mist (a solid component, for example a metallic component, in the gas generating agent which is generated by combustion of the gas generating agent). However, when the through hole in the combustion chamber housing and the inner wall surface of the cylindrical housing are positioned directly opposite one another, the combustion gas that is ejected through the through hole first collides against the inner wall surface of the cylindrical housing. At this time, the temperature of the inner wall surface is lower than that of the mist, and hence the mist component adheres to the inner wall surface and hardens. Thus the amount of mist reaching the diffuser portion is reduced.

The hybrid inflator of the present invention may also be designed such that the combustion chamber housing comprises a peripheral wall portion and a base portion, the combustion chamber housing is connected to the first communication path at the opening portion, a through hole(s) is provided in both the peripheral wall portion and the base portion, a total opening area of the through holes in the peripheral wall portion is larger than a total opening area of the through hole in the base portion, and the through holes in the peripheral wall portion are positioned directly opposite an inner wall surface of the cylindrical housing with a gap therebetween.

By providing a further through hole in the base portion of the combustion chamber housing, the speed with which the internal pressure of the cylindrical housing rises can be increased in comparison with a case in which high temperature combustion gas is ejected only from the peripheral wall portion. In particular, by positioning the through hole in the base portion directly opposite the second rupturable plate, and using helium, which has a high sound velocity, as the pressurized gas, the combustion gas ejected through the through hole in the base portion advances toward the second rupturable plate as a shock wave, and impinges on the second rupturable plate at high speed, thereby improving the rupturability of the second rupturable plate.

The hybrid inflator of the present invention may also be designed such that the combustion chamber housing comprises a peripheral wall portion and a base portion, the combustion chamber housing is connected to the first communication path at the opening portion, the through hole(s) are provided in at least the peripheral wall portion, and an opening ratio of the through holes provided in the peripheral wall portion increases toward the base portion.

The opening ratio of the through holes corresponds to the opening area per unit area, and is adjusted by applying a method of altering the hole diameter without changing the number of through holes (in other words, a method of increasing the diameter of only the through holes near the base portion among evenly disposed through holes, or a method of gradually increasing the hole diameter of the through holes toward the base portion), or a method of increasing the number of through holes without altering the hole diameter of the through holes (in other words, a method of increasing the formation density of the holes). Note that the through holes may be provided in the peripheral wall portion alone, or in both the peripheral wall portion and base portion.

By increasing the opening ratio of the through holes toward the base portion of the combustion chamber housing (in other words, away from the igniter) in this manner, a situation in which only the gas generating agent in the vicinity of the igniter burns well and the gas generating agent removed from the igniter (i.e. near the base portion) burns poorly can be prevented. Moreover, the combustion gas moves more easily from the combustion chamber housing into the cylindrical housing, and hence stable combustion can be obtained.

The reason for this is as follows. In an initial stage when the gas generating agent inside the combustion chamber housing has begun to burn, only the gas generating agent in the vicinity of the igniter ignites and burns, whereas the gas generating agent near the base portion remains in an unburned state. Hence, by increasing the proportion of through holes toward the base portion, the combustion gas flows to the base portion more easily, enabling the unburned gas generating agent to ignite and burn favorably.

The inflator of the present invention is particularly suitable as a curtain air bag inflator or side air bag inflator for use in lateral collisions, but may also be applied as an inflator for a driver side, an inflator for a front passenger side, a knee bolster inflator, and so on.

In the hybrid inflator of the present invention, the ignitability and combustibility of the gas generating agent is improved, and hence the time required to eject gas from the gas discharge port can be shortened. Accordingly, the hybrid inflator of the present invention may be applied favorably to an air bag system for use in lateral collisions, in which a short air bag inflation time is required.

### BRIEF DESCRIPTION OF THE DRAWINGS

FIG. 1 is a sectional view of a hybrid inflator in the axial direction thereof;

FIG. 2 is a partial sectional view of another embodiment of the hybrid inflator in FIG. 1; and

FIG. 3 is a longitudinal sectional view of a combustion chamber housing, serving as a different embodiment to that shown in FIG. 1.

### DESCRIPTION OF REFERENCE NUMERALS

10 hybrid inflator
11 cylindrical housing
12 sealed space
20 igniter housing
22 igniter
30 diffuser portion
32 gas discharge port
40 combustion chamber housing
41 gas generating agent
45a, 45b through holes
50 first rupturable plate
55 second rupturable plate
   Preferred Embodiment of the Invention

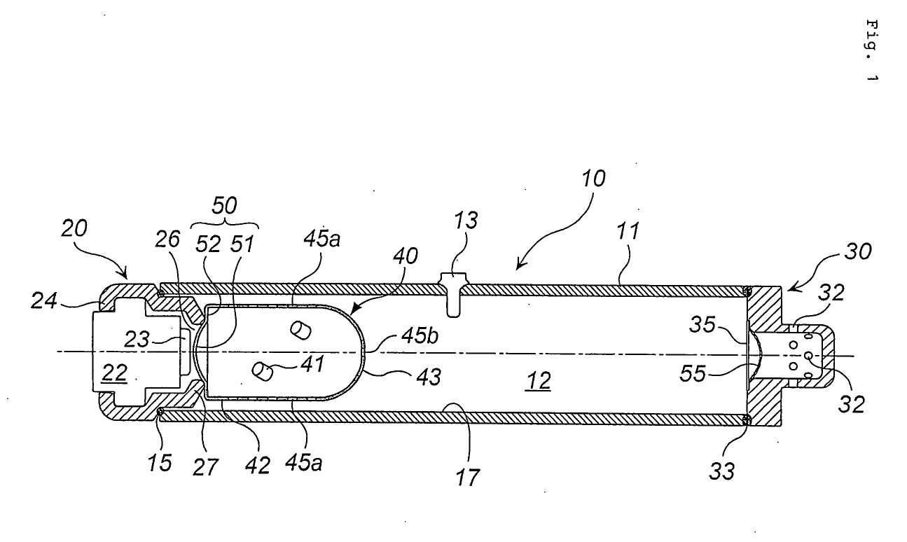

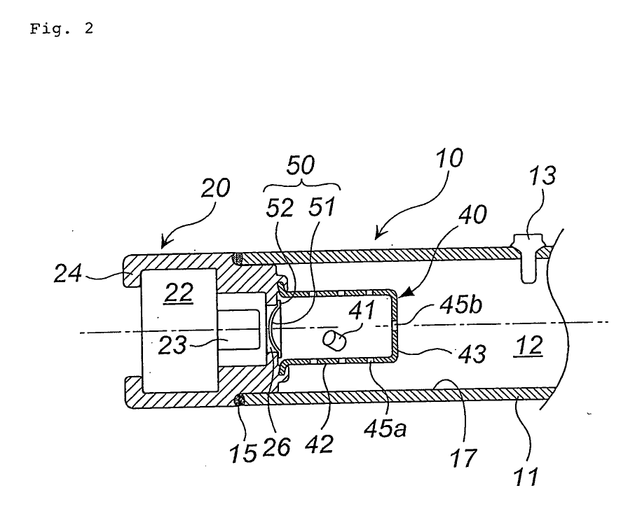

Embodiments of a hybrid inflator will be described using FIGS. 1 and 2. FIG. 1 is a sectional view of a hybrid inflator in the axial direction thereof, and FIG. 2 is a partial sectional view of another embodiment.

The outer shell of a hybrid inflator 10 comprises a cylindrical housing 11, an igniter housing 20, and a diffuser portion 30.

The cylindrical housing 11 is a container made of highly pressure-resistant steel or the like, and a pressurized gas such as helium, argon, or nitrogen gas is charged into a sealed space 12 in the interior thereof. Helium is preferable as the pressurized gas due to its high sound velocity (970 m/sec). The charging pressure is set approximately 70,000 kPa at a maximum pressure. The pressurized gas is charged through a gap between a pin 13 and a side wall of the cylindrical housing 11. The pin 13 is fixed to the side wall by welding.

The igniter housing 20 accommodating ignition means is fixed to an opening portion on one end of the cylindrical housing 11 by welding at a welded portion 15.

As the ignition means, an electric igniter 22 provided with an ignition agent in a crown portion (ignition portion) 23 thereof is accommodated inside the igniter housing 20. The igniter 22 is fixed by crimping an opening portion peripheral edge 24 on one end side of the igniter housing 20. Note that the igniter 22 may be fixed by setting the igniter 22 in the igniter housing 20 so that a gap is produced therebetween, filling the gap with a thermoplastic resin, and causing the thermoplastic resin to harden.

The diffuser portion 30, provided with plural gas discharge ports 32, is fixed to an opening portion at the other end of the cylindrical housing 11 by welding at a welded portion 33.

A combustion chamber housing 40 is disposed inside the cylindrical housing 11 (sealed space 12), and a required amount of a gas generating agent 41 is stored in the interior space of the combustion chamber housing 40.

The combustion chamber housing 40 comprises a peripheral wall portion 42 and a hemispherical base portion 43. Plural through holes 45a are provided in the peripheral wall portion 42, and a through hole 45b is also provided in the center of the base portion 43. The through holes may be provided in one or both of the peripheral wall portion 42 and the base portion 43.

Providing the through holes 45a in the peripheral wall portion 42 is preferable for producing the mist-reducing action described above, and by providing the through hole 45b in the base portion 43, the progression of the shock wave (generated by combustion of the gas generating agent or an operation of the igniter) in the sealed space 12 can be used to improve the rupturability of a second rupturable plate 55.

Further, the through hole 45b provided in the base portion 43 is preferably positioned directly opposite the second rupturable plate 55. By disposing the through hole 45b and second rupturable plate 55 directly opposite each other in this manner, the shock wave produced by the combustion gas that is ejected through the through hole 45b advances directly toward and collides with the second rupturable plate 55, thus improving the rupturability thereof.

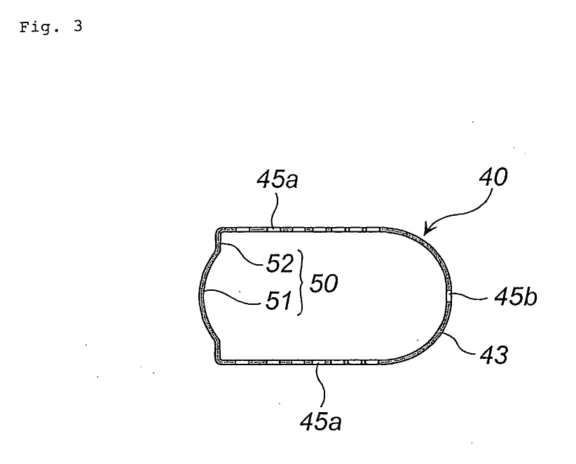

By increasing the number of through holes 45a away from the igniter 22, or in other words toward the base portion 43, as shown in FIG. 3, the opening ratio can be increased, enabling an improvement in the ignitability and combustibility of the gas generating agent 41.

A first communication path 26 between the igniter housing 20 and combustion chamber housing 40 is closed by a first rupturable plate 50. The first rupturable plate 50 is directly opposite to the crown portion 23 of the igniter 22.

The first rupturable plate 50 comprises a circular closing portion 51 which closes the first communication path 26, and a fixing portion 52 on the peripheral edge of the closing portion 51. The outer diameter of the first rupturable plate 50 (closing portion 51+fixing portion 52) is similar to the inner diameter of the combustion chamber housing 40.

As shown in FIG. 1, the first rupturable plate 50 may be formed integrally with the combustion chamber housing 40. In this case, the surface opposite the base portion 43 of the combustion chamber housing 40 forms the first rupturable plate 50. The first rupturable plate 50 and combustion chamber housing 40 are both fixed by welding the fixing portion 52 of the first rupturable plate 50 to an opening portion peripheral edge 27 of the igniter housing 20.

When the first rupturable plate 50 and combustion chamber housing 40 are formed as an integral body, a weak portion is preferably provided in the central portion of the closing portion 51 of the first rupturable plate 50. By providing such a weak portion, it is possible to ensure that the closing portion 51 alone ruptures reliably, thus improving the ignitability of the gas generating agent 41.

As shown in FIG. 2, the first rupturable plate 50 and combustion chamber housing 40 may also be provided as separate members. In this case, the first rupturable plate 50 and combustion chamber housing 40 are fixed to the opening portion peripheral edge 27 of the igniter housing 20 separately by welding. When provided as separate members in this manner, although fixing work is required for each of the first rupturable plate 50 and the combustion chamber housing 40, charging the gas generating agent 41 into the combustion chamber housing 40 and forming the combustion chamber housing 40 become easier.

The diffuser portion 30 and a second communication path 35 of the cylindrical housing 11 are closed by the second rupturable plate 55. The peripheral edge portion of the second rupturable plate 55 is fixed to the diffuser portion 30 by welding.

Next, an operation when the hybrid inflator 10 is incorporated into an air bag system of an automobile will be described.

When the vehicle crashes, the igniter 22 activates to rupture the closing portion 51 of the first rupturable plate 50. The gas generating agent 41 is then ignited and burned by ignition energy flowing into the combustion chamber housing 40. At this time, since the diameter of the first rupturable plate 50 and the inner diameter of the combustion chamber housing 40 are similar, the ignition energy passes over the gas generating agent 41 in the combustion chamber housing 40 with great efficiency, and thus the gas generating agent 41 achieves favorable ignitability and combustibility.

The high temperature combustion gas generated by combustion of the gas generating agent 41 is ejected through the plural through holes 45a in the peripheral wall portion 42 and the single through hole 45b in the base portion 43. Since the total opening area of the through holes 45a is larger than the opening area of the through hole 45b, more high temperature combustion gas is ejected through the through holes 45a than the through hole 45b.

Having been ejected through the through holes 45a, the high temperature combustion gas collides against an inner wall surface 17 of the cylindrical housing 11, but since the temperature of the inner wall surface 17 is low, the mist contained in the high temperature combustion gas adheres to the inner wall surface 17, hardens, and is thus collected. As a result, the amount of mist in the high temperature combustion gas is reduced.

Meanwhile, high temperature combustion gas is also ejected through the through hole 45b, and hence the internal pressure of the sealed space 12 is raised also by the high temperature combustion gas that is ejected through the through hole 45b. At this time, the combustion gas ejected through the through hole 45b forms a shock wave which advances directly toward and collides against the second rupturable plate 55.

As a result, the second rupturable plate 55 is ruptured, the pressurized gas and high temperature combustion gas are discharged through the gas discharge ports 32, and the air bag is inflated. When helium is used as the pressurized gas, the sound velocity is great, and hence the propagation speed of the shock wave is high, preferably enabling the desired effect of a reduction in the rupture time of the second rupturable plate 55.

1. A hybrid inflator comprising a cylindrical housing, both ends of which are open and the interior of which is charged with a pressurized gas, an igniter housing attached to an opening portion on one end of the cylindrical housing, in which ignition means are accommodated, and a diffuser portion attached to an opening portion on the other end of the cylindrical housing and provided with a gas discharge port,
wherein the hybrid inflator further comprises a combustion chamber housing storing a gas generating agent, which is disposed within the cylindrical housing, connected to the igniter housing, and provided with through holes in a wall surface thereof,
a first communication path between the igniter housing and the combustion chamber housing is closed by a first rupturable plate, and a second communication path between the diffuser portion and the cylindrical housing is closed by a second rupturable plate,
the first rupturable plate comprises a circular closing portion which closes the first communication path, and a fixing portion on the peripheral edge of the closing portion, and the outer diameter of the first rupturable plate and the inner diameter of the combustion chamber housing are identical or similar.

2. The hybrid inflator according to claim 1, wherein the combustion chamber housing and the first rupturable plate are formed integrally.

3. The hybrid inflator according to claim 2, wherein the first rupturable plate has a weak portion.

4. The hybrid inflator according to claim 1 or 2, wherein the combustion chamber housing comprises a peripheral wall portion and a base portion, the combustion chamber housing is connected to the first communication path at the opening portion, the through holes are provided only in the peripheral wall portion, and the through holes are positioned directly opposite an inner wall surface of the cylindrical housing with a gap therebetween.

5. The hybrid inflator according to claim 1 or 2, wherein the combustion chamber housing comprises a peripheral wall portion and a base portion, the combustion chamber housing is connected to the first communication path at the opening portion, the through holes are provided in both the peripheral wall portion and the base portion, a total opening area of the through holes in the peripheral wall portion is larger than a total opening area of the through hole in the base portion, and the through holes in the peripheral wall portion are positioned directly opposite an inner wall surface of the cylindrical housing with a gap therebetween.

6. The hybrid inflator according to claim 1 or 2, wherein the combustion chamber housing comprises a peripheral wall portion and a base portion, the combustion chamber housing is connected to the first communication path at the opening portion, the through holes are provided in at least the peripheral wall portion, and an opening ratio of the through holes provided in the peripheral wall portion increases toward the base portion.
